(19) United States
(12) Patent Application Publication
(10) Pub. No.: US 2020/0340586 A1
(43) Pub. Date: Oct. 29, 2020

(54) SEAL ASSEMBLY

(71) Applicant: Carl Freudenberg KG, Weinheim (DE)

(72) Inventors: Frank Lauer, Rauenberg (DE); Christian Kohl, Weinheim (DE); Thomas Kramer, Rimbach (DE)

(21) Appl. No.: 16/955,783

(22) PCT Filed: Dec. 12, 2018
(86) PCT No.: PCT/EP2018/084471

§ 371 Date: Jun. 19, 2020

(30) Foreign Application Priority Data
Dec. 21, 2017 (DE) 10 2017 011 930.9

(51) Int. Cl. F16J 15/16; F16J 15/3212; F16J 15/322; F16J 15/3236

(52) U.S. Cl. CPC F16J 15/166; F16J 15/3236; F16J 15/322; F16J 15/3212

(57) ABSTRACT

A seal assembly includes: a first seal element; and a pressing element. The first seal element is a groove ring and has a first seal lip and a second seal lip. The pressing element is arranged between the first seal lip and the second seal lip and effects a radial pre-tensioning of the first seal lip and the second seal lip. The pressing element closes a gap between the first seal lip and the second seal lip.

### CROSS-REFERENCE TO PRIOR APPLICATIONS

This application is a U.S. National Phase application under 35 U.S.C. § 371 of International Application No. PCT/EP2018/084471, filed on Dec. 12, 2018, and claims benefit to German Patent Application No. DE 10 2017 011 930.9, filed on Dec. 21, 2017. The International Application was published in German on Jun. 27, 2019 as WO 2019/121196 under PCT Article 21(2).

### FIELD

The invention relates to a seal assembly comprising a first seal element and a pressing element, wherein the first seal element is designed as a groove ring and has a first seal lip and a second seal lip, wherein the pressing element is arranged between the first seal lip and the second seal lip and effects a radial pre-tensioning of the first seal lip and the second seal lip.

### BACKGROUND

Seal assemblies of this type are known from general mechanical engineering and are used, for example, as rod seals or piston seals, for example for sealing translationally moving machine elements. In this case, the first seal element rests with the first seal lip on the housing and the second seal lip on the machine element to be sealed. The pressing element, which is arranged between the two seal lips, effects a radial pre-tensioning of the two seal lips against the housing and the machine element and thereby ensures the tightness of the seal assembly.

Providing as the pressing element one or more spring bodies, which are arranged in the groove that results between the first seal lip and the second seal lip, is known from the prior art. In this case, it is problematic that medium to be sealed can come into contact with the spring bodies, wherein medium to be sealed can remain in the groove between the two seal lips and in particular also in the spring body, such that dead spaces and non-cleanable gaps result here. Seals of this type are therefore not suitable for use in food technology. In this context, providing groove rings with a lining of silicone materials is also known. However, such linings are complex to produce.

### SUMMARY

In an embodiment, the present invention provides a seal assembly, comprising: a first seal element; and a pressing element, wherein the first seal element comprises a groove ring and has a first seal lip and a second seal lip, wherein the pressing element is arranged between the first seal lip and the second seal lip and effects a radial pre-tensioning of the first seal lip and the second seal lip, and wherein the pressing element closes a gap between the first seal lip and the second seal lip.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a seal assembly in section;

FIG. 2 shows a seal assembly in accordance with FIG. 1 with a shoulder projecting radially outwards;

FIG. 3 shows a seal assembly with a spring body;

FIG. 4 shows a double-sided seal assembly;

FIG. 5 shows a seal assembly with an optimized geometry;

FIG. 6 shows a seal assembly with an axial seal.

### DETAILED DESCRIPTION

In an embodiment, the present invention provides a seal assembly which, with a good sealing effect, is suitable for use in food technology.

In an embodiment, the seal assembly comprises a first seal element and a pressing element, wherein the first seal element is designed as a groove ring and has a first seal lip and a second seal lip, wherein the pressing element is arranged between the first seal lip and the second seal lip and effects a radial pre-tensioning of the first seal lip and the second seal lip against the machine element to be sealed and the housing, wherein the pressing element closes the gap between the first seal lip and the second seal lip and thus forms on the medium side an even face which is free of dead space.

In this case, it is advantageous that the space formed by the groove is closed so that no medium can penetrate into this space. A further advantage is that the pressing element is designed such that it only comes into contact with medium to be sealed with a relatively small contact surface. Furthermore, the pressing element is designed such that no medium to be sealed remains in the pressing element. As a result, the seal assembly is designed without dead space and is suitable in particular for use in food technology.

The first seal element can be made of polymeric material. A particularly suitable polymeric material is PTFE, for example. PTFE has particularly low friction and is resistant to most media to be sealed, in particular most media to be sealed from the field of food technology. Furthermore, PTFE is resistant to cleaning agents such as are used, for example, in clean-in-place cleaning (CIP cleaning) and are approved for contact with foodstuffs. In CIP cleaning, the components of a food technology installation, such as the seal assembly, are cleaned in place without disassembly.

Due to its shape, the seal assembly according to the invention is particularly suitable for CIP cleaning because, neither cleaning agents nor residual product can remain in dead spaces.

The pressing element can be made of an elastomeric material. The pressing element thereby effects a constant pressing of the first seal element against the machine element. Fluorine rubber is an advantageous elastomeric material for use in food technology. Comparable to PTFE, fluorine rubber is resistant to most media and can moreover be used over a wide temperature spectrum. In addition to fluorine rubber, ethylene propylene diene rubber (EPDM) is also used. The pressing element can be produced in a variety of shapes. The pressing element can be matched to the shape of the groove and the desired pressing of the two seal lips against the machine element.

The pressing element can close the gap between the first seal lip and the second seal lip flush with the free ends of the first seal lip and the second seal lip. This results in an even side which is assigned to the space to be sealed or to the surroundings. In this embodiment, the contour of the seal element is planar on the media side. The penetration of media into the seal assembly can thereby be prevented. Such a seal assembly is free of dead space and is suitable for use in food technology. Moreover, the pressing element results in a defined and permanent pressing of the seal assembly against the machine element to be sealed and thereby a high sealing effect.

A spring body can be arranged between the first seal lip and the second seal lip. The spring body effects an additional radial pre-tensioning of the first seal lip and the second seal lip, such that the permanent sealing effect is improved even more as a result. In this case, the spring body is concealed by the pressing element in the direction of the space to be sealed, such that the spring body does not come into contact with the medium to be sealed.

The pressing element can be held by a form fit in the gap between the first seal lip and the second seal lip. For this purpose, the first seal element and the pressing element can be provided with a suitable form-fitting geometry. The form-fit connection fixes the pressing element in a captive manner in the first seal element, which is advantageous in particular during transport and installation of the seal assembly. However, the form-fit connection also prevents the pressing element from migrating out due to dynamic stress and operating-related pressure fluctuations and temperature changes.

At least one compensating chamber can be formed between the seal element and the pressing element. The compensating chamber makes it possible to compensate for changes in shape of the seal element and of the pressing element due to thermal expansions and media swelling.

The pressing element can be supported axially on the groove base of the first seal element. This improves the behavior of the seal assembly during pressurization.

The first seal element can have a third seal lip and a fourth seal lip, which project into the side facing away from the first seal lip and the second seal lip, wherein a second pressing element is arranged in the gap between the third seal lip and the fourth seal lip. This results in a seal assembly for translationally moving machine elements, which seals equally well in both axial directions. A shoulder projecting radially outwards can be formed from the first seal element. The seal assembly can be positioned in a fixed position in a housing by means of the shoulder.

The figures show a seal assembly 1 with a first seal element 2 and a pressing element 3, wherein the first seal element 2 is designed as a groove ring. The first seal element 2 has a first seal lip 4 and a second seal lip 5. The pressing element 3 is arranged between the first seal lip 4 and the second seal lip 5 and effects a radial pre-tensioning of the first seal lip 4 and the second seal lip 5. The pressing element 3 is designed such that it closes the gap between the first seal lip 4 and the second seal lip 5. The first seal element 2 and the pressing element 3 are even on the end face along a radial plane. A seal assembly 1 with an even end face free of dead space is formed.

The first seal element 2 is made of a polymeric material, here PTFE, and the pressing element 3 is made of an elastomeric material, here fluorine rubber.

The pressing element 3 is held by a form fit in the gap between the first seal lip 4 and the second seal lip 5. For this purpose, the first seal lip 4 has a first projection 9 projecting radially inwards and the second seal lip 5 has at its free end a circumferential second projection 10 projecting radially into the interior of the groove ring. This results in an undercut in the gap in which the pressing element 3 engages after installation. The pressing element 3 has a circumferential bead 11 on the outer circumferential side and on the inner circumferential side, which are designed and arranged on the pressing element 3 such that they rest against the inwardly facing sides of the first projection 9 and the second projection 10 after installation of the pressing element 3 in the first seal element 2. After installation, the two beads 11 accordingly lie axially behind the first projection 9 and the second projection 10. During installation, the beads 11 snap in behind the first projection 9 and the second projection 10 in a captive manner.

The inner circumference of the first projection 9 and the outer circumference of the second projection 10 are cylindrical in shape. On the end facing outwards, the pressing element 3 has a tubular section which comes to rest in a sealing manner on the cylindrical faces of the first projection 9 and the second projection 10. The gap between the first seal lip 4 and the second seal lip 5 is closed by this arrangement. At the same time, the pressing of the seal lips 4, 5 and thus also the sealing effect is increased. The inwardly facing end of the pressing element 3 is beveled on the inner circumference and on the outer circumference, such that the cross section of the pressing element 3 tapers in the direction of the groove base 18.

The pressing element 3 is designed here such that it is supported axially on the groove base 18 of the seal element 2, in order to withstand pressurization.

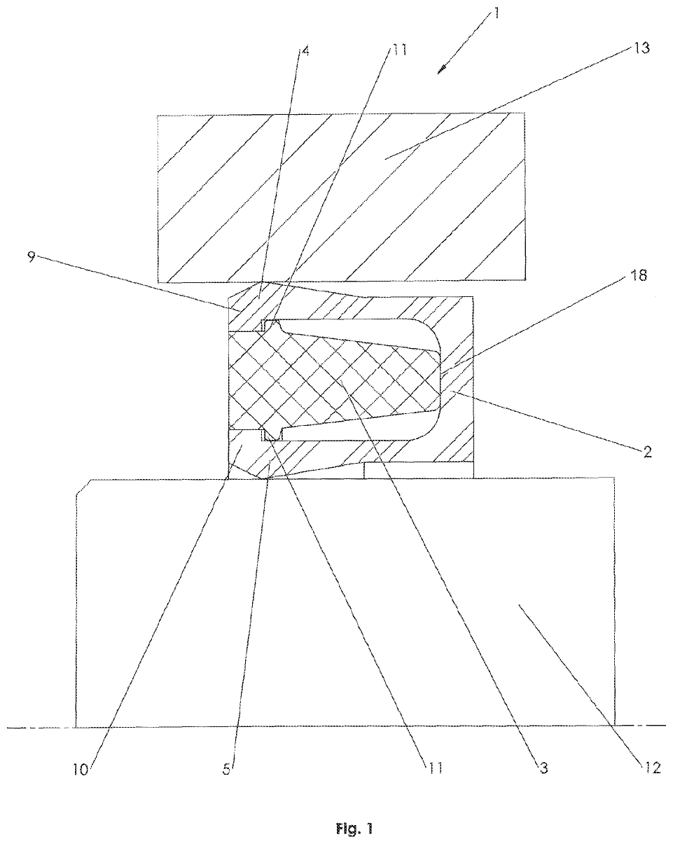

FIG. 1 shows in section a seal assembly 1 for sealing a translationally moving machine element 12. In this case, the first seal lip 4 rests in a sealing manner against the housing 13 and the second seal lip 5 rests in a sealing manner against the translationally moving machine element 12. The machine element 12 is presently a piston rod.

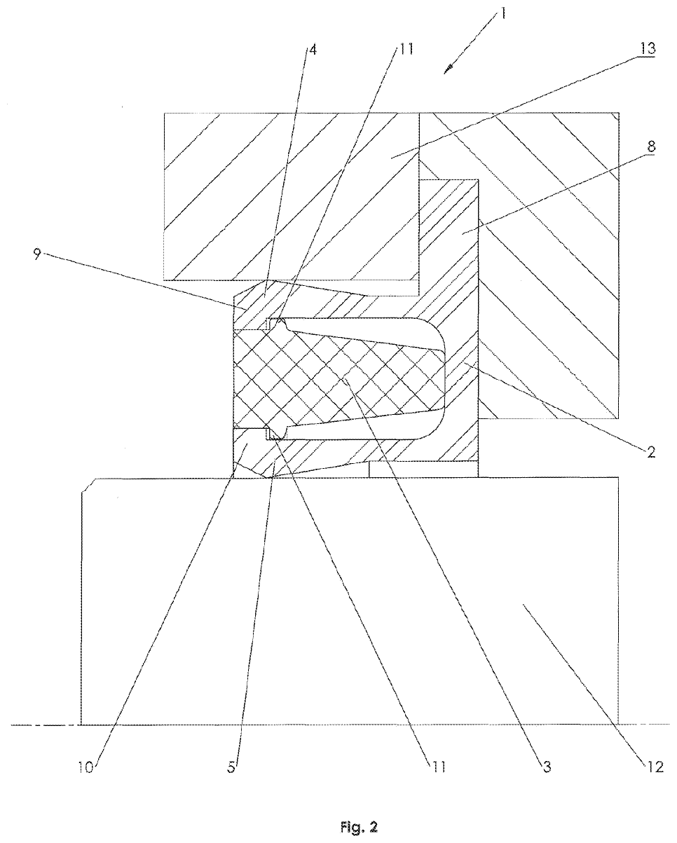

FIG. 2 shows a seal assembly 1 in accordance with FIG. 1, wherein the first seal element 2 is additionally equipped with a shoulder 8, which projects radially outwards from the first seal element 2 and serves for installation in a housing 13. After installation, the shoulder 8 is clamped in the housing 13, such that the seal element 2 is secured in the housing 13 in a rotation-proof manner by the shoulder 8. Such a seal element 2 is suitable in particular for sealing rotationally moving machine elements 12. In this respect, the machine element 12 is designed as a rotating shaft in the embodiment shown in FIG. 2. It is also conceivable for the machine element 12 to move both rotationally and translationally.

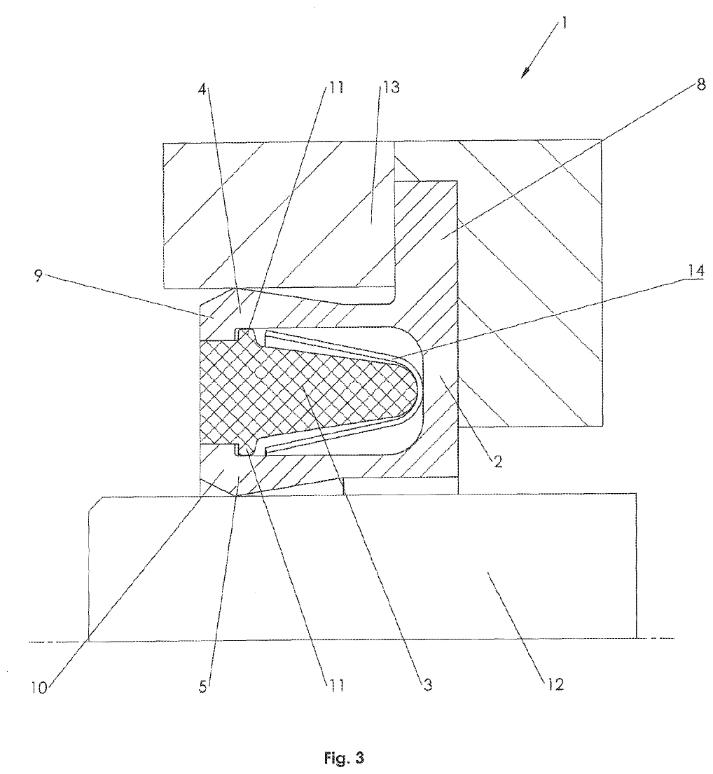

FIG. 3 shows a seal assembly 1 in accordance with FIG. 2. A spring body 14 is additionally arranged between the first seal lip 4 and the second seal lip 5. The spring body 14 has a V-shaped cross section and is arranged in the gap between the first seal element 2 and the pressing element 3. Due to the sealing arrangement of the pressing element 3 between the first seal lip 4 and the second seal lip 5, the spring body 14 does not come into contact with the medium to be sealed. The spring body 14 is made of metallic material. The spring body 14 can be annular or can also be composed of individual segments.

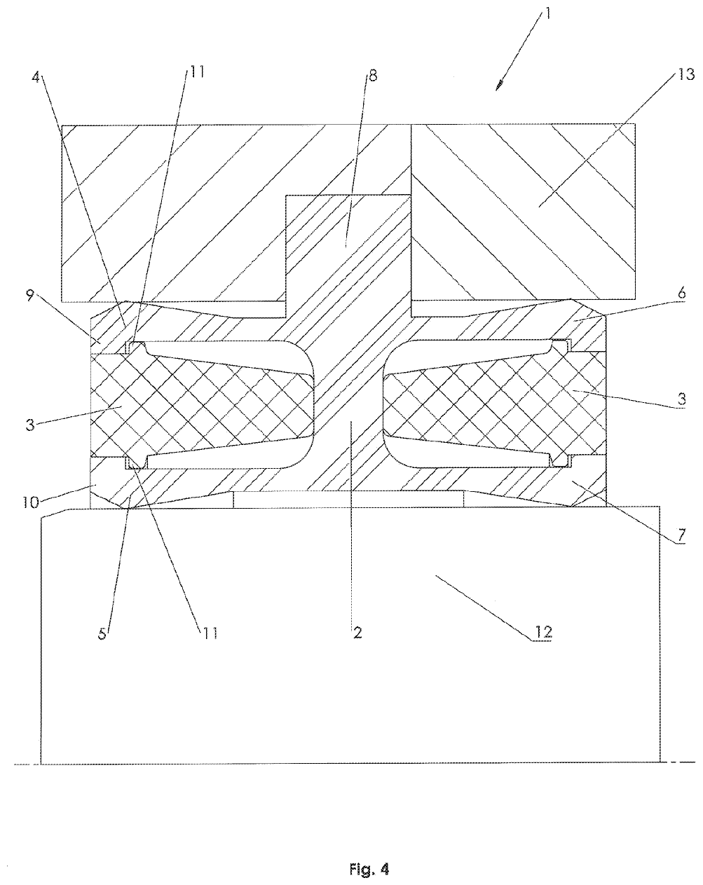

FIG. 4 shows a seal assembly 1, wherein the first seal element 2 has a third seal lip 6 and a fourth seal lip 7, which project into the side facing axially away from the first seal lip 4 and the second seal lip 5, wherein a further pressing element 3 is arranged in the gap between the third seal lip 6 and the fourth seal lip 7. This results in a seal assembly 1, which is suitable for sealing translationally moving machine elements 12 in both axial directions. Between the first seal lip 4 and the second seal lip 5 as well as between the third seal lip 6 and the fourth seal lip 7, a spring body 14 can be arranged in each case, which is covered in each case by the pressing element 3 in the direction of the space to be sealed. Due to the optimum design with a shoulder 8 which is clamped in the housing 13 after installation, the seal element 2 is, however, also particularly suitable for sealing rotationally moving machine elements 12.

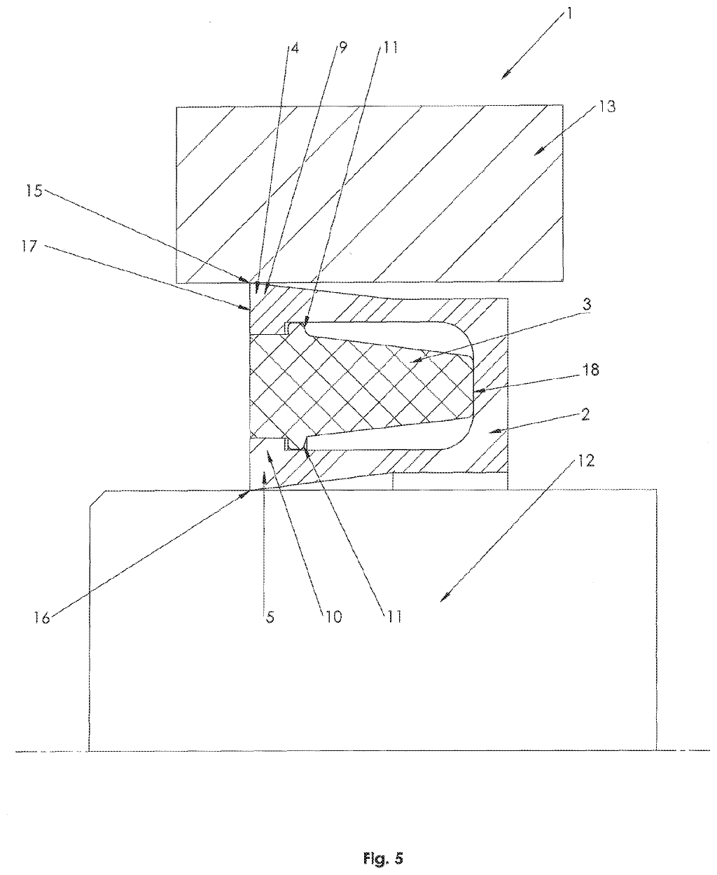

FIG. 5 shows a development of the seal assembly in accordance with FIG. 1. In the present embodiment, the seal lips 4, 5 have sealing edges 15, 16, which are aligned with the end face 17 of the seal element 2 and the pressing element 3. As a result, the end face 17 of the seal assembly 1 does not have any gaps and is free of dead space.

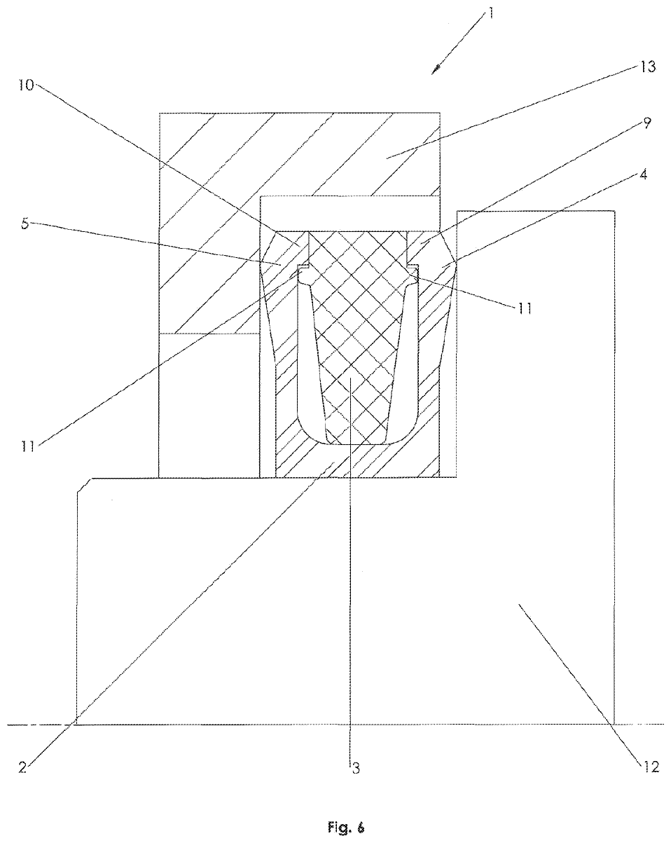

FIG. 6 shows an alternative seal assembly 1 with a first seal element 2 and a pressing element 3, wherein the first seal element 2 is designed as a groove ring. The seal element 2 is oriented such that a sealing effect arises in the axial direction. The first seal element 2 has a first seal lip 4 and a second seal lip 5. The pressing element 3 is arranged between the first seal lip 4 and the second seal lip 5 and effects an axial pre-tensioning of the first seal lip 4 and the second seal lip 5. The pressing element 3 is designed such that it closes the gap between the first seal lip 4 and the second seal lip 5.

The first seal element 2 is made of a polymeric material, here PTFE, and the pressing element 3 is made of an elastomeric material, here fluorine rubber.

The pressing element 3 is held by a form fit in the gap between the first seal lip 4 and the second seal lip 5. For this purpose, the first seal lip 4 has a first projection 9 projecting axially inwards and the second seal lip 5 has at its free end a circumferential second projection 10 projecting axially into the interior of the groove ring. This results in an undercut in the gap in which the pressing element 3 engages after installation. The pressing element 3 has a circumferential bead 11 on each of the two sides, which is designed and arranged on the pressing element 3 such that they rest against the inwardly facing sides of the first projection 9 and the second projection 10 after installation of the pressing element 3 in the first seal element 2. After installation, the two beads 11 accordingly lie radially below the first projection 9 and the second projection 10. During installation, the beads 11 snap in behind the first projection 9 and the second projection 10 in a captive manner.

The faces of the first projection 9 and the second projection 10 that are facing each other are annular and planar. On the end facing radially outwards, the pressing element 3 has a tubular section, which comes to rest in a sealing manner on the annular faces of the first projection 9 and the second projection 10. The gap between the first seal lip 4 and the second seal lip 5 is closed by this arrangement. At the same time, the pressing of the seal lips 4, 5 and thus also the sealing effect is increased. The radially inwardly facing end of the pressing element 3 is beveled laterally such that the cross section of the pressing element 3 tapers in the direction of the groove base.

The machine element 12 has a shoulder, on the side of which the seal element 2 comes to rest. The inner circumferential side of the seal element rests against the machine element. Furthermore, the seal element is supported on a side of the housing 13.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A seal assembly, comprising:
a first seal element; and
a pressing element,
wherein the first seal element comprises a groove ring and has a first seal lip and a second seal lip,
wherein the pressing element is arranged between the first seal lip and the second seal lip and effects a radial pre-tensioning of the first seal lip and the second seal lip, and
wherein the pressing element closes a gap between the first seal lip and the second seal lip.

2. The seal assembly according to claim 1, wherein the first seal element comprises a polymeric material.

3. The seal assembly according to claim 1, wherein the pressing element comprises an elastomeric material.

4. The seal assembly according to claim 1, wherein the pressing element closes the gap between the first seal lip and the second seal lip flush with the first seal lip and the second seal lip.

5. The seal assembly according to claim 1, further comprising a spring body arranged between the first seal lip and the second seal lip.

6. The seal assembly according to claim 5, wherein the pressure element covers the spring body in a direction of a medium to be sealed by the seal assembly.

7. The seal assembly according to claim 1, wherein the pressing element is held by a form fit in the gap between the first seal lip and the second seal lip.

8. The seal assembly according to claim 1, wherein at least one compensating chamber is formed between the first seal element and the pressing element.

9. The seal assembly according to claim 1, wherein the pressing element is supported axially on a groove base of the first seal element.

10. The seal assembly according to claim 1, wherein the first seal element has a third seal lip and a fourth seal lip, which project into a side facing away from the first seal lip and the second seal lip, and
wherein a further pressing element is arranged in a gap between the third seal lip and the fourth seal lip.

11. The seal assembly according to claim 1, wherein a shoulder projecting radially outwards is formed from the first seal element.

12. A pressing element for a first seal element having a first seal lip and a second seal lip, the pressing element comprising:
a spring body arranged between the first seal lip and the second seal lip.
